(19) United States
(12) Patent Application Publication
(10) Pub. No.: US 2017/0159707 A1
(43) Pub. Date: Jun. 8, 2017

(54) FAN

(71) Applicant: MINEBEA CO., LTD., Kitasaku-gun (JP)

(72) Inventors: Takayuki YAMAWAKI, Kakegawa-shi (JP); Kazuhiro MORI, Hamamatsu-shi (JP)

(73) Assignee: MINEBEA CO., LTD., Kitasaku-gun (JP)

(21) Appl. No.: 15/354,295

(22) Filed: Nov. 17, 2016

(30) Foreign Application Priority Data
Dec. 2, 2015 (JP) 2015-235618

(51) Int. Cl. F16C 25/08; F04D 25/06; F04D 25/08; F16C 19/54; F04D 29/059

(52) U.S. Cl. CPC F16C 25/083; F16C 19/548; F04D 29/059; F04D 25/08; F04D 25/06; F16C 2360/46

(57) ABSTRACT

A fan includes a shaft, a first rolling bearing provided on one end side of the shaft in an axial direction of the shaft and having a first inner ring on an outer circumference side of the shaft and a first outer ring on an outer side in a radial direction of the first inner ring, a second rolling bearing provided on another end side of the shaft and having a second inner ring on the outer circumference side of the shaft and a second outer ring on the outer side in a radial direction of the second inner ring, a bearing housing accommodating the first and second rolling bearings, an elastic member between the first and second rolling bearings. At least one of the first and second rolling bearings is a loose-fit bearing. A resistance-applying part is interposed between the loose-fit bearing and the elastic member.

### CROSS REFERENCE TO RELATED APPLICATIONS

This application claims the benefit of Japanese Patent Application No. 2015-235618, filed Dec. 2, 2015, which is hereby incorporated by reference in its entirety.

### BACKGROUND

Technical Field

The present disclosure relates to a fan.

Background Art

A fan of the related art provided with a bearing having a constant pressure preload structure between a shaft and a bearing liner has the following features. The bearing having a constant pressure preload structure has: a first rolling bearing loosely fitted between the shaft and the bearing liner on one end side of the shaft, and including an inner ring on the shaft side and an outer ring on the bearing liner side; a second rolling bearing loosely fitted between the shaft and the bearing liner on the other end side of the shaft, and including an inner ring on the shaft side and an outer ring on the bearing liner side; and a compression coil spring disposed between the first rolling bearing and the second rolling bearing. The bearing liner has, on its inner periphery, a protrusion on which the outer ring of the first rolling bearing abuts and a first end part of the compression coil spring on one end abuts. The compression coil spring has, on its other end, a second end part abutting on the outer ring of the second rolling bearing, and an outer diameter of a middle portion between the first end part and the second end part is smaller than an outer diameter of at least one of the first end part and the second end part (see Japanese Patent Laid-Open No. 2014-129743).

In the constant pressure preload structure of Japanese Patent Laid-Open No. 2014-129743, there is a clearance between the bearing and the bearing liner (a bearing housing). Hence, when the structure is used in a high-speed fan or the like, the bearing may roll inside the bearing housing.

That is, the outer ring of the bearing pressed by the compression coil spring to apply preload may roll inside the bearing housing.

This generates friction between the outer ring of the bearing and an inner circumference surface of the bearing housing, whereby the outer ring of the bearing or the inner circumference surface of the bearing housing may wear or be damaged by frictional heat.

Further, if powder generated by the wear enters inside the bearing, smooth movement between the inner ring and the outer ring of the bearing is hindered, and malfunction may be caused.

The present disclosure is related to providing a fan that suppresses wear, damage and malfunction due to rolling of a bearing.

### SUMMARY

In accordance with one aspect of the present disclosure, a fan includes: a shaft; a first rolling bearing provided on one end side of the shaft in an axial of the shaft, the first rolling bearing having a first inner ring disposed on an outer circumference side of the shaft and a first outer ring disposed on an outer side in a radial direction of the first inner ring; a second rolling bearing provided on another end side of the shaft in the axial direction of the shaft, the second rolling bearing having a second inner ring disposed on the outer circumference side of the shaft and a second outer ring disposed on the outer side in a radial direction of the second inner ring; a bearing housing accommodating the first rolling bearing and the second rolling bearing; an elastic member disposed at a position between the first rolling bearing and the second rolling bearing, at least one of the first rolling bearing and the second rolling bearing being a loose-fit bearing fitted with a clearance; and a resistance-applying part interposed between the loose-fit bearing and the elastic member.

Preferably, the fan further includes a hub holder provided closer to the one end side of the shaft than the first rolling bearing. The first inner ring and the second inner ring are fixed to the shaft, while the first outer ring is fixed to the bearing housing. The second outer ring is loose-fitted to the bearing housing, and an end portion of the elastic member on the other end side presses the second outer ring via the resistance-applying part.

Preferably, the resistance-applying part includes a ring-shaped rubber interposed between the end portion of the elastic member on the other end side, and the second outer ring.

Preferably, the resistance-applying part includes a coating that generates resistance, is the coating being formed on one of an end surface of the second outer ring on the elastic member side and at least the end portion of the elastic member on the other end side.

Preferably, the bearing housing has a receiving portion that protrudes radially inward from an inner circumference surface of the bearing housing to receive an end portion of the first outer ring on the other end side; and an end portion of the elastic member of the one end side abuts the receiving portion.

Preferably, the elastic member is a spring.

According to the present disclosure, it is possible to provide a fan that suppresses wear, damage and malfunction due to rolling of a bearing.

### BRIEF DESCRIPTION OF THE DRAWINGS

FIG. 1 is a cross-sectional view of a fan of an embodiment of the present disclosure.

FIG. 2 is an enlarged cross-sectional view of the periphery of a bearing housing of the embodiment of the present disclosure.

FIG. 3A is a perspective view showing a first modification of a member that constitutes a resistance-applying part of the embodiment of the present disclosure.

FIG. 3B is a perspective view showing a second modification of a member that constitutes the resistance-applying part of the embodiment of the present disclosure.

FIG. 3C is a perspective view showing a third modification of a member that constitutes the resistance-applying part of the embodiment of the present disclosure.

FIG. 3D is a perspective view showing a fourth modification of a member that constitutes the resistance-applying part of the embodiment of the present disclosure.

### DETAILED DESCRIPTION

Hereinafter, an embodiment of the present disclosure will be described in detail with reference to the accompanying drawings.

Note that the same components are assigned the same reference numerals throughout the description of the embodiment.

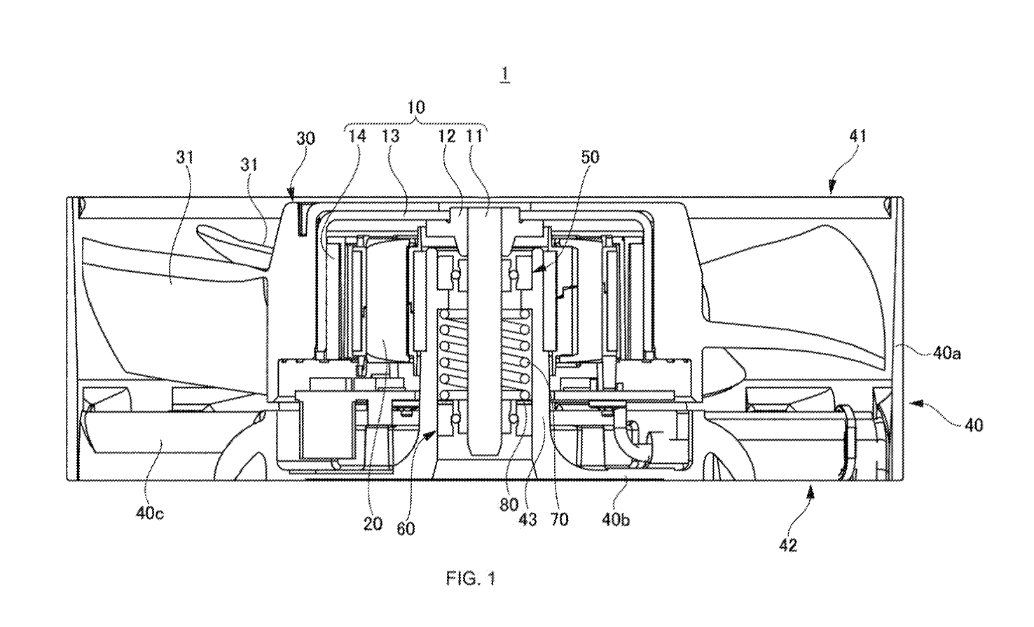

FIG. 1 is a cross-sectional view of a fan 1 of the embodiment of the present disclosure.

As shown in FIG. 1, the fan 1 includes a rotor 10, a stator 20, an impeller 30, and a housing 40.

The rotor 10 includes a shaft 11, a hub holder 12 fixed to one end side (an upper side in FIG. 1) of the shaft 11, a cup-shaped hub 13 fixed to the hub holder 12 and functioning as a rotor yoke, and a rotor magnet 14 fixed to an inner circumference surface of the hub 13.

The impeller 30 having a plurality of blades 31 is attached on the hub 13 so as to be integral with the hub 13.

Accordingly, rotation of the rotor 10 around the shaft 11 serving as a rotation axis causes the impeller 30 to rotate integrally with the rotor 10, whereby air is sucked in through an intake port 41 of the housing 40, and the air sucked in through the intake port 41 is discharged through an exhaust port 42.

The housing 40 includes a side wall portion 40a surrounding the outer periphery of the impeller 30, a base portion 40b provided closer to the center than the exhaust port 42, and a plurality of stationary blades 40c connecting the base portion 40b and the side wall portion 40a. A bearing housing 43 is formed integrally with the base portion 40b at the center of the base portion 40b.

The bearing housing 43 is a part that accommodates a first rolling bearing 50 and a second rolling bearing 60 to be described later.

Note that the base portion 40b and the side wall portion 40a do not necessarily have to be connected by the stationary blades 40c, and may be connected by a rib-like member.

Also, although the bearing housing 43 is formed integrally with the base portion 40b in the present embodiment, the bearing housing 43 may be formed as a separate part attached to the base portion 40b, or the bearing housing 43 prepared as a separate part may be integrated with the housing 40 as an insert member, when forming the housing 40.

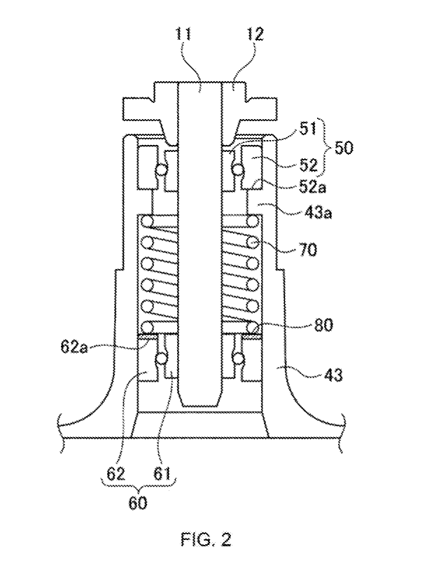

Next, attachment of the rotor 10 will be described in detail with reference to FIG. 2.

FIG. 2 is an enlarged cross-sectional view of the periphery of the bearing housing 43.

Note that FIG. 2 shows only the shaft 11 and the hub holder 12 of the rotor 10.

As shown in FIG. 2, the first rolling bearing 50 is provided on the one end side (an upper side in FIG. 2) of the shaft 11 in the axial direction of the shaft 11, the first rolling bearing 50 having a first inner ring 51 disposed on an outer circumference surface of the shaft 11, and a first outer ring 52 disposed on an outer side in a radial direction of the first inner ring 51. The first rolling bearing 50 is fixed to the shaft 11 by press-fitting the shaft 11 into the first inner ring 51.

Note that the first rolling bearing 50 may be fixed to the shaft 11 by adhering the first inner ring 51 to the shaft 11.

The hub holder 12 is fixed to the shaft 11 by press fitting or the like at a position closer to the one end side of the shaft 11 than the first rolling bearing 50, but the hub holder 12 also may be fixed by adhering.

The bearing housing 43 has a ring-shaped receiving portion 43a protruding radially inward from an inner circumference surface of the bearing housing 43, at a position corresponding to the first rolling bearing 50 provided on the one end side (the upper side in FIG. 2) of the shaft 11. The receiving portion 43a receives an end portion 52a of the first outer ring 52 of the first rolling bearing 50 facing toward the other end side (a lower side in FIG. 2) of the shaft 11.

Hence, by press-fitting the first outer ring 52 of the first rolling bearing 50 into the bearing housing 43 until a position where the first outer ring 52 abuts the receiving portion 43a, the first rolling bearing 50 is fixed to the bearing housing 43 such that the first rolling bearing 50 is at a predetermined position.

Note that the fixing of the first outer ring 52 may also be adhesion to the bearing housing 43.

Additionally, the second rolling bearing 60 is provided on another end side (the lower side in FIG. 2) of the shaft 11 in the axial direction of the shaft 11, the second rolling bearing 60 having a second inner ring 61 disposed on the outer circumference side of the shaft 11, and a second outer ring 62 disposed on the outer side in a radial direction of the second inner ring 61. The second rolling bearing 60 is fixed to the shaft 11 by press-fitting the shaft 11 into the second inner ring 61.

Note that the second rolling bearing 60 may be fixed to the shaft 11 by adhering the second inner ring 61 to the shaft 11.

On the other hand, the second outer ring 62 of the second rolling bearing 60 is loosely fitted to the bearing housing 43 to allow movement in the axial direction of the shaft 11.

An elastic member 70 formed of a spring (a compression coil spring) is disposed between the first rolling bearing 50 and the second rolling bearing 60. The elastic member 70 presses the second rolling bearing 60 in such a manner as to apply a predetermined preload.

More specifically, an end portion (an end portion on the upper side in FIG. 2) of the elastic member 70 on the one end side of the shaft 11 in the axial direction of the shaft 11 abuts the receiving portion 43a of the bearing housing 43, and an end portion (an end portion on the lower side in FIG. 2) of the elastic member 70 on the other end side of the shaft 11 in the axial direction of the shaft 11 presses an end portion 62a of the second outer ring 62 of the second rolling bearing 60 facing toward the one end side of the shaft 11, toward the other end side of the shaft 11 in the axial direction of the shaft 11.

As described above, the second outer ring 62 is fitted loosely.

Hence, the second outer ring 62 is pressed and moved to the other end side (the lower side in FIG. 2) of the shaft 11 in the axial direction of the shaft 11, by a biasing force of the elastic member 70.

Then, the second inner ring 61 also moves to the other end side (the lower side in FIG. 2) of the shaft 11 in the axial direction of the shaft 11, and the first inner ring 51 of the first rolling bearing 50 moves to the other end side (the lower side in FIG. 2) of the shaft 11 in the axial direction of the shaft 11, via the shaft 11.

As a result, a predetermined pressure is applied to ball members placed between the inner rings (the first inner ring 51, the second inner ring 61) and the outer rings (the first outer ring 52, the second outer ring 62) of the first rolling bearing 50 and the second rolling bearing 60. In other words, an appropriate preload is applied to the first rolling bearing 50 and the second rolling bearing 60 with the elastic member 70. Hence, whirling and vibration caused by rotation of the shaft 11 are suppressed.

In the embodiment, the second rolling bearing 60 is a loose-fit bearing fitted with a clearance, and a resistance-applying part 80 includes a ring-shaped rubber for generating resistance is provided, between the second rolling bearing 60 as the loose-fit bearing and the elastic member 70.

More specifically, a ring-shaped rubber sheet conformed to the shape of the end portion 62a of the second outer ring 62 of the second rolling bearing 60 facing the one end side of the shaft 11, is disposed on an end surface of the end portion 62a of the second outer ring 62 facing toward the one end side of the shaft 11, to form the resistance-applying part 80.

Then, the end portion (the end portion on the lower side in FIG. 2) of the elastic member 70 on the other end side of the shaft 11 in the axial direction of the shaft 11 is brought into contact with the resistance-applying part 80 including the ring-shaped rubber sheet, so that the resistance-applying part 80 is interposed between the end portion of the elastic member 70 on the other end side and the second outer ring 62.

With this, since the ring-shaped rubber sheet has high resistance and slippage is less likely to occur, the second outer ring 62 does not slip with respect to the elastic member 70, even if the shaft 11 rotates at high speed and rotary force of the second inner ring 61 is transmitted to the second outer ring 62. Thus, rotation of the second outer ring 62 is suppressed.

This suppresses friction resulting from rotation of the second outer ring 62, and also suppresses generation of powder by wear, and therefore prevents powder from entering the second rolling bearing 60 and causing malfunction.

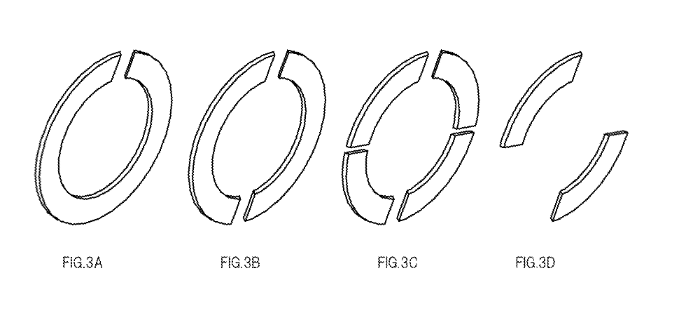

In the above embodiment, although a case where the resistance-applying part 80 for generating resistance is configured of a ring-shaped rubber has been described, the resistance-applying part 80 is not limited to the ring-shaped rubber form, and may be configured of those shown in FIGS. 3A to 3D.

FIGS. 3A to 3D are perspective views showing modifications of a member that constitutes the resistance-applying part 80.

A first modification in FIG. 3A is a case where the member constituting the resistance-applying part 80 is a C ring-shaped rubber sheet. Use of such a member can achieve effects similar to the above embodiment.

Similarly, a second modification in FIG. 3B is a case where a ring-shaped rubber sheet is divided into two, and a third modification in FIG. 3C is a case where a ring-shaped rubber sheet is divided into four.

Such configurations can also achieve effects similar to the above embodiment, by arranging the divided members annularly on the end surface of the end portion 62a of the second outer ring 62 of the second rolling bearing 60.

A fourth modification in FIG. 3D is a case where only two of the members divided into four of the ring-shaped rubber sheet in FIG. 3C are used. Even this configuration can achieve effects similar to those described above, by placing the members between the end portion 62a of the second outer ring 62 of the second rolling bearing 60, and the end portion of the elastic member 70 on the other end side.

Note that the ring-shaped rubber sheet of the embodiment or any of the modifications (first to fourth modifications) shown in FIGS. 3A to 3D should preferably be fixed, for example, by adhering to the end portion 62a of the second outer ring 62 of the second rolling bearing 60, to prevent movement of the member for generating resistance.

Moreover, although the above description has been given of a case where a rubber sheet was used as the resistance-applying part 80, the resistance-applying part 80 is not limited to the rubber sheet.

For example, the end surface of the end portion 62a of the second outer ring 62 may be provided with a coating that generates resistance, or, on the other hand, at least the end portion of the elastic member 70 on the other end side may be provided with a coating that generates resistance.

The coating may be, for example, an adhesive, paint, or cladding provided on the end surface of the end portion 62a of the second outer ring 62 or the end portion of the elastic member 70 on the other end side, but not particularly limited, as long as it can increase the resistance of the surface, and suppress slippage between the second outer ring 62 of the second rolling bearing 60 and the elastic member 70.

Although the present disclosure has been described on the basis of the embodiment, the present disclosure is not limited to the embodiment.

In the above embodiment, although the second rolling bearing 60-side is a loose-fit bearing fitted with a clearance, the first rolling bearing 50-side may be a loose-fit bearing fitted with a clearance instead, and be biased by being applied a preload with the elastic member 70.

Also, although the above embodiment describes a case of loose-fitting the outer ring, the inner ring may be fitted with a clearance instead.

For example, one of the first rolling bearing 50 and the second rolling bearing 60 may be formed as a loose-fit bearing by: fixing the first outer ring 52 of the first rolling bearing 50 and the second outer ring 62 of the second rolling bearing 60 to the bearing housing 43; and fixing the first inner ring 51 of the first rolling bearing 50 or the second inner ring 61 of the second rolling bearing 60 to the shaft 11, while fitting the other inner ring with a clearance to the shaft 11.

In this case, in order to apply a preload, the elastic member 70 biases the first inner ring 51 and the second inner ring 61 in directions that increase a gap between the first inner ring 51 and the second inner ring 61. Since the end surface of the inner ring is likely to slip, the resistance-applying part 80 may be provided between the end portion of the elastic member 70 on the one end side in the axial direction of the shaft 11 and the first inner ring 51 and between the end portion of the elastic member 70 on the other end side in the axial direction of the shaft 11 and the second inner ring 61.

With this configuration, the inner ring (the first inner ring 51 or the second inner ring 61) of the first rolling bearing 50 or the second rolling bearing 60 fixed to the shaft 11 surely rotates with the shaft 11, and the elastic member 70 also rotates without slipping with respect to the inner ring (the first inner ring 51 or the second inner ring 61). Hence, the inner ring (the second inner ring 61 or the first inner ring 51) fitted with a clearance to the shaft 11 can also surely rotate with the shaft 11.

Accordingly, it is possible to suppress friction between the shaft 11 and the loosely fitted inner ring (the second inner ring 61 or the first inner ring 51), and suppress generation of powder due to wear, for example.

Furthermore, in the above embodiment, the resistance-applying part 80 is not interposed between the ring-shaped receiving portion 43a protruding radially inward from the inner circumference surface of the bearing housing 43, and the end portion of the elastic member 70 on the one end side in the axial direction of the shaft 11.

This is because slippage is less likely to occur as compared to the end surfaces of the outer ring or inner ring of the bearing. However, if slippage in this area is also of a concern the resistance-applying part 80 may be provided between the ring-shaped receiving portion 43a protruding radially inward from the inner circumference surface of the bearing housing 43, and the end portion of the elastic member 70 on the one end side of the shaft 11 in the axial direction of the shaft 11.

As has been described, the present disclosure is not limited to the specific embodiments, and it is clear to those skilled in the art from the scope of subject matters defined by the claims, that various changes can be made without departing from the scope of the disclosure.

What is claimed is:

1. A fan comprising:
a shaft;
a first rolling bearing provided on one end side of the shaft in an axial direction of the shaft, the first rolling bearing having a first inner ring disposed on an outer circumference side of the shaft and a first outer ring disposed on an outer side in a radial direction of the first inner ring;
a second rolling bearing provided on another end side of the shaft in the axial direction of the shaft, the second rolling bearing having a second inner ring disposed on the outer circumference side of the shaft and a second outer ring disposed on the outer side in a radial direction of the second inner ring;
a bearing housing accommodating the first rolling bearing and the second rolling bearing;
an elastic member disposed at a position between the first rolling bearing and the second rolling bearing, at least one of the first rolling bearing and the second rolling bearing being a loose-fit bearing fitted with a clearance; and
a resistance-applying part interposed between the loose-fit bearing and the elastic member.

2. The fan according to claim 1, further comprising a hub holder provided closer to the one end side of the shaft than the first rolling bearing, wherein:
the first inner ring and the second inner ring are fixed to the shaft, and the first outer ring is fixed to the bearing housing;
the second outer ring is loose-fitted to the bearing housing; and
an end portion of the elastic member on the other end side presses the second outer ring via the resistance-applying part.

3. The fan according to claim 2, wherein
the resistance-applying part includes a ring-shaped rubber interposed between the end portion of the elastic member on the other end side, and the second outer ring.

4. The fan according to claim 2, wherein
the resistance-applying part includes a coating that generates resistance, the coating being formed on one of an end surface of the second outer ring on the elastic member side and at least the end portion of the elastic member on the other end side.

5. The fan according to claim 1, wherein:
the bearing housing has a receiving portion that protrudes radially inward from an inner circumference surface of the bearing housing to receive an end portion of the first outer ring on the other end side; and
an end portion of the elastic member of the one end side abuts the receiving portion.

6. The fan according to claim 1, wherein
the elastic member is a spring.
